(19) United States
(12) Patent Application Publication
(10) Pub. No.: US 2012/0118599 A1
(43) Pub. Date: May 17, 2012

(54) Hand-Held Power Tool, in particular Electric Hand-Held Power Tool

(75) Inventors: Joachim Schadow, Stuttgart (DE); Joerg Maute, Sindelfingen (DE); Manfred Lutz, Filderstadt (DE)

(73) Assignee: Robert Bosch GmbH, Stuttgart (DE)

(21) Appl. No.: 13/319,667

(22) PCT Filed: Apr. 15, 2010
(86) PCT No.: PCT/EP2010/054924

§ 371 Date: Jan. 30, 2012

(30) Foreign Application Priority Data
May 11, 2009 (DE) 10 2009 002 967.2

(51) Int. Cl. B25F 5/02

(52) U.S. Cl. 173/162.2

(57) ABSTRACT

A hand-held power tool has a housing comprising at least two separate and interconnected housing parts, wherein one housing part forms a handle part for holding and guiding the hand-held power tool. At least two vibration reduction elements are arranged in the force transmission path between the housing parts.

The invention relates to a hand-held power tool, in particular an electric hand-held power tool, according to the preamble of claim 1.

### PRIOR ART

DE 10 2005 016 453 A1 discloses an angle grinder which has an electric drive motor in a motor housing, wherein a housing cover adjoins the motor housing and is separated from the motor housing via an annular circumferential damping element, such that vibrations which emanate from the motor housing spread to the housing cover only in a reduced manner.

### DISCLOSURE OF THE INVENTION

The object of the invention is to achieve an effective reduction of vibrations in the handle part of a hand-held power tool with simple design measures.

This object is achieved according to the invention by the features of claim 1. The dependent claims specify expedient developments.

The hand-held power tool according to the invention is a motor-driven hand-held power tool which is driven in particular via an electric drive motor which is arranged in a motor housing of the hand-held power tool. The motor housing forms a first housing part which is connected to a second housing part which forms a handle part and via which the hand-held power tool can be held and guided by an operator.

Arranged between the two housing parts is a vibration reduction element, the task of which is to reduce vibrations which emanate from the drive unit or occur during the machining of a workpiece to such an extent that there is a significant attenuation of vibrations in the handle part. In addition, this improves operator comfort.

According to the invention, at least two vibration reduction elements connected in series are arranged in the force transmission path between the two housing parts. On account of the series connection, an improved reduction of vibrations is achieved compared with embodiments known from the prior art or the same vibration reduction effect can be achieved with simpler vibration reduction elements or with vibration reduction elements of smaller dimensions. Furthermore, there are additional design possibilities, for example such that the at least two vibration reduction elements, which are connected in series, are arranged on different sides of a projection, fastening step or the like.

The vibration reduction elements can be arranged one behind the other in the force transmission path both in the axial direction and in the radial direction—with respect to the housing axis or motor axis. Furthermore, it is possible for the two vibration reduction elements to both be arranged directly adjacent to one another and placed at a distance from one another, where in the latter case a further component can also be arranged between the vibration reduction elements without the vibration-reducing effect being restricted as a result. In this way, it is also possible to arrange the vibration reduction elements at different positions and in a different axial direction, provided the series connection in the force transmission direction between the housing parts is maintained. For example, a first vibration reduction element can be arranged with an axial orientation and a second vibration reduction element connected in series can be arranged with a radial orientation between the housing parts.

According to an advantageous embodiment, a connecting flange is formed on one of the housing parts, wherein the two vibration reduction elements are arranged on different sides of the connecting flange. The connecting flange is formed in particular on the handle part, which in a preferred embodiment of the handle part as a handle sleeve or in a pot shape can be realized by virtue of the fact that a section of the handle part that projects beyond the rear axial end face of the motor housing has a connecting flange which extends radially inward and on which the vibration reduction elements are held. In this embodiment, said vibration reduction elements are adjacent to the rear axial end face of the motor housing; they therefore extend in the axial direction with respect to the housing longitudinal axis.

The handle part of pot-shaped design encloses the motor housing, the walls of the handle part advantageously being at a distance from the wall of the motor housing in order to avoid direct contact and thus the occurrence of vibration transmission bridges. To securely retain the handle part on the motor housing, a connecting element, for example a screw, is advantageously provided, wherein the connecting element can be passed through an aperture which is made in one or in both vibration reduction elements. The vibration reduction elements are, for example, of disk-shaped design, the central aperture in the vibration reduction elements serving for accommodating the connecting element. In the embodiment as a screw, the connecting element clamps the two vibration reduction elements, arranged on different sides of the connecting flange, with an axial clamping force against the rear end face of the motor housing, as a result of which the axial position of the handle part with respect to the motor housing is established.

In order to also establish the radial position of the handle part relative to the motor housing, an additional vibration reduction element is advantageously arranged between the motor housing and the enclosing handle part. If need be, this additional vibration reduction element can develop its vibration-reducing effect not only in the radial direction but also in the axial direction.

Suitable vibration reduction elements are both damping elements and spring elements. In this case, the damping elements expediently consist of a damping material, for example PUR, an elastomer or a gel-like material or the like. Suitable spring elements are various spring types, for example helical springs or leaf springs. The reduction of vibrations through the use of spring elements is achieved by a change in the transmitted vibrations with regard to the frequency and the amplitude, in particular via a shift from critical to non-critical frequencies. Relevant attenuation of vibrations in the handle part can also be achieved in this way.

According to a further aspect of the invention, in the case of a hand-held power tool which has a housing with two separate housing parts which are to be connected to one another and of which one housing part forms a handle part for holding and guiding the hand-held power tool, the outer side of the handle part consists at least partly of a vibration-damping material. In this embodiment, too, a vibration reduction element is expediently arranged between the two housing parts. Various material types, e.g. thermoplastics, thermoplastic elastomers, thermosetting plastics, elastomers, etc., are suitable as vibration-damping material. Furthermore, damping pads or damping elements which are filled with a soft or resilient material, for example silicone, gel, gas, grease, oil or other fluids or media, can also be provided. A combination of such fluids with foams, for example metal foams, with metal pads or metal or wire meshes is also possible. Finally, it is also possible to achieve a significant reduction of vibrations via an appropriate geometry or design of the vibration-damping material, for example by the arrangement of knitted meshes of metals, plastics or other materials, where a combination of different materials may also be suitable.

In principle, it is sufficient for the outer side of the handle part to have an appropriate vibration-damping coating by the outer side of the handle part, for example, being coated with an elastomer. However, it is also possible to apply an independent component made of a vibration-damping material directly to the outer side of the handle part. In addition, this variant has the advantage that a surface-increasing geometry on the outer side of the handle part can be achieved in a simple manner, for example by handle knobs which project radially outward being integrally formed on said outer side, said handle knobs being inherently elastically resilient, as a result of which a further reduction of vibrations is achieved. However, such surface-increasing geometries can also be achieved by virtue of the fact that the outer side of the handle part consisting of a hard material has an appropriate design and is covered with vibration-damping material or that vibration-damping material having appropriate geometry is sprayed onto the outer side of the handle part.

Further advantages and expedient embodiments can be seen from the further claims, from the description of the figures and from the drawings, in which:

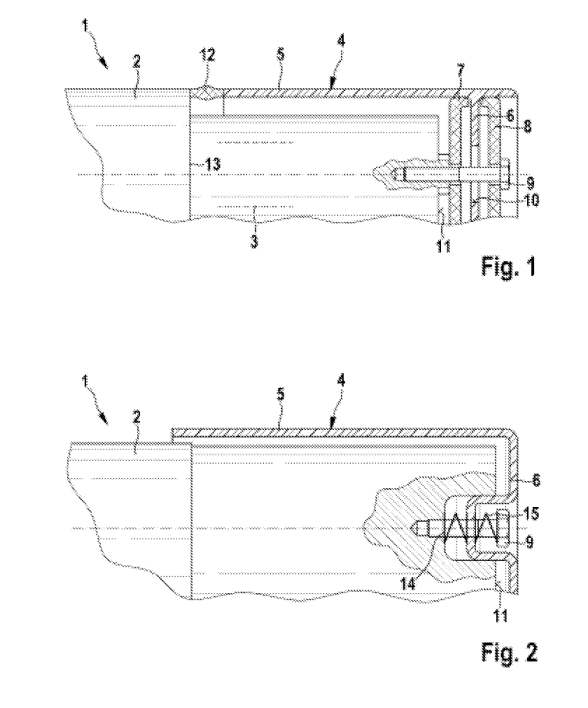

FIG. 1 shows a hand-held power tool in section which has a motor housing and a pot-shaped handle housing pushed onto the motor housing, wherein two parallel, disk-shaped damping elements are arranged at the rear axial end face of the motor housing on a connecting flange which is formed in one piece with the handle housing,

FIG. 2 shows a hand-held power tool in a further embodiment in which the base of the pot-shaped handle housing is connected to the motor housing via a screw, wherein two helical springs lying axially one behind the other are pushed onto the screw,

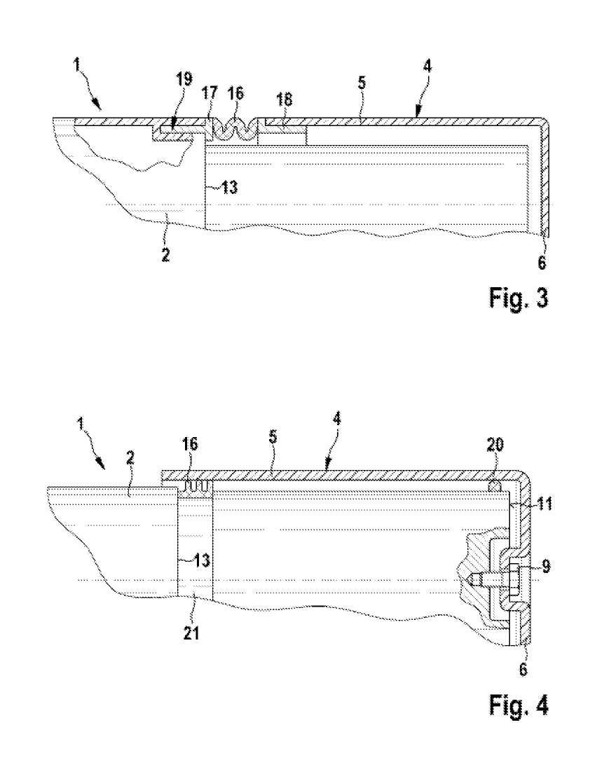

FIG. 3 shows a further exemplary embodiment for a hand-held power tool in which the axial end face of the pot-shaped handle-housing is supported on the motor housing via an axially acting damping element,

FIG. 4 shows a further exemplary embodiment in which a radially acting damping element is arranged in the region of the free axial end face of the handle housing between the outer side of the motor housing and the inner side of the handle housing,

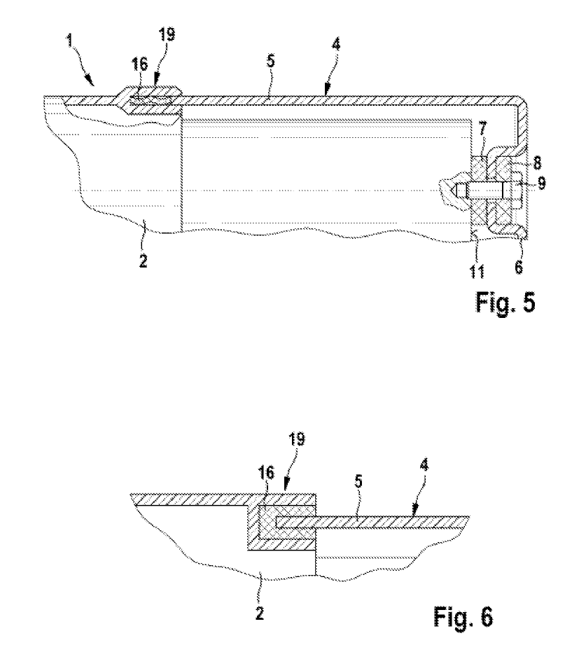

FIG. 5 shows a further exemplary embodiment in which a damping element is active in the axial direction on the axial end face of the handle housing, said damping element being arranged in an accommodating pocket which is formed in one piece with the motor housing,

FIG. 6 shows a further exemplary embodiment for a damping element which is inserted into an accommodating pocket in the motor housing,

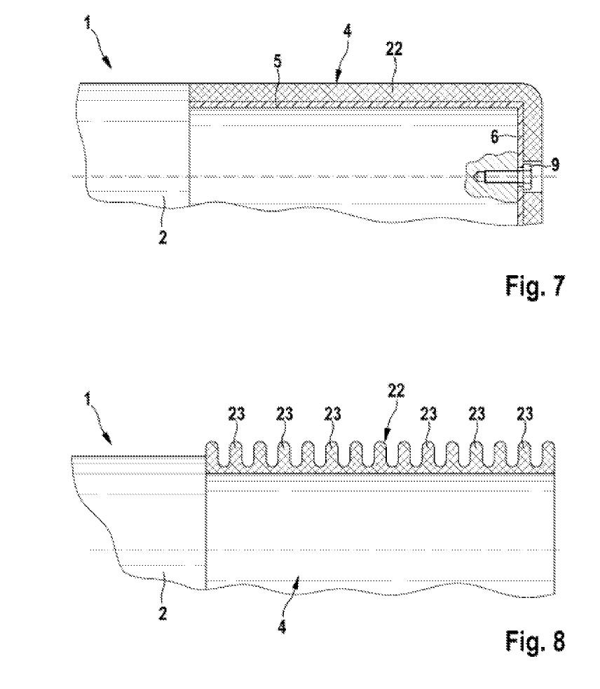

FIG. 7 shows a further exemplary embodiment in which the outer side of the handle housing is covered with a vibration-damping coating,

FIG. 8 shows a further exemplary embodiment in which the outer side of the handle housing is likewise covered with a vibration-damping coating which is additionally provided with radially projecting handle knobs.

In the figures, the same components are provided with the same reference numerals.

The hand-held power tool 1 shown in FIG. 1 comprises, as housings, a motor housing 2, in which an electric drive motor 3 and possibly further components such as electronic components, switches or the like are arranged, and a handle housing or handle part 4 which is connected to the motor housing 2 and is taken hold of by the operator for guiding and holding the hand-held power tool 1. The handle part 4 is pushed onto the motor housing 2 and comprises a cylindrical handle section 5, which encloses the outer side of the motor housing 2 at a radial distance, and a connecting flange 6 on the base side, which possibly at the same time forms the base plate of the handle part 4. The connecting flange 6 is at an axial distance from the rear axial end face 11 of the motor housing 2.

To reduce vibrations which spread from the motor housing 2 in the direction of the handle part 4, damping elements 7 and 8 connected in series are arranged in the force transmission path from the motor housing 2, said damping elements 7 and 8 each being of disk-shaped design and being located in parallel and at an axial distance from the rear axial end face 11 of the motor housing 2. The two disk-shaped damping elements 7 and 8, which each have a central aperture, are located at different end faces of the connecting flange 6, which forms the base plate and is formed in one piece with the handle part 4. A central aperture 10 is likewise made in the connecting flange 6. The force-transmitting connection between the motor housing 2 and the handle part 4 is realized with the aid of a connecting element which is embodied as a screw 9 in the exemplary embodiment and is screwed in the axial direction of the housing to the axial rear end face 11 of the motor housing 2. The screw 9 is passed through the central apertures in the two damping elements 7 and 8 and through the aperture 10 in the connecting flange 6 and therefore connects both the two damping elements 7 and 8 and also the connecting flange 6 and thus the entire handle part 4 axially to the motor housing 2. In this case, one end face of the first damping element 7 directly facing the motor housing 2 is in contact with the rear axial end face 11 of the motor housing 2 and the opposite end face of said first damping element 7 is in contact with the connecting flange 6. One end face of the second damping element 8 is likewise in contact with the opposite side of the connecting flange 6, whereas the opposite end face of said second damping element 8 is acted upon by the screw head of the screw 9. This ensures that, despite the screw 9 which connects the handle part 4 to the motor housing 2, there is no vibration transmission bridge between motor housing 2 and handle part 4. Despite the screw 9, there is no direct contact with the motor housing 2 and the handle part 4; on the contrary, all the vibration-transmitting components are isolated via the damping elements 7 and 8. It should be noted that the aperture 10 in the connecting element 6 is designed with regard to the positioning and the diameter in such a way that the lateral surface of the screw 9 is not in contact with the wall sections directly defining the aperture 10.

A further damping element 12, which is of annular design, is located between the free axial end face of the cylindrical handle section 5 of the handle part 4 and an encircling step 13, which forms an annular shoulder, on the motor housing 2. The damping element 12 is clamped in place axially between the end face of the handle part 4 and the step 13 on the motor housing 2 and isolates the handle part 4 from the motor housing 2 in the axial direction. The damping element 2 is subjected to an axial force on account of the contact force which is exerted axially on the handle part 4 by the screw 9.

In the exemplary embodiment according to FIG. 2, too, the handle part is of pot-shaped design and is pushed axially onto the rear section of the motor housing 2. The axial connection between motor housing 2 and handle part 4 is likewise effected via the base plate 6 with the aid of a connecting element which is embodied as a screw 9 and which is passed through an aperture in the base plate 6 and is screwed to the rear axial end face of the motor housing 2. To reduce vibrations, two vibration reduction elements connected in series are likewise provided in the force transmission path, said vibration reduction elements being designed, according to FIG. 2, as spring elements 14 and 15. The spring elements 14 and 15 are embodied as helical springs and are pushed onto the screw 9 on opposite sides of the base plate 6, such that direct contact between the base plate 6 and the screw 9 is likewise avoided. The effect of the spring elements 14 and 15 is that the vibrations emanating from the motor housing 2 are transmitted to the handle part 4 in a modified form with regard to their frequency and amplitude, thereby reducing the vibration load in the handle part.

In the exemplary embodiments according to FIGS. 1 and 2, the vibration reduction elements are connected in series in the axial direction, with respect to the longitudinal axis of the housing or of the drive motor of the hand-held power tool. Instead of or in addition to positioning the two vibration reduction elements in the region of the rear axial end face of the motor housing 2, an axial series connection in the region of the free end face of the handle part 4 is also possible. Furthermore, it is also conceivable for the series connection to be effected in the radial direction, for example in the intermediate annular space between the outer side of the motor housing 2 and the inner side of the enclosing handle part 4.

The exemplary embodiment according to FIG. 3 shows a further variant for sealing the free axial end face of the handle part 4 relative to the motor housing 2. Provided in this region is an encircling, annular sealing element 16 which is held axially at its two end faces on fastening parts 17 and 18, of which the fastening part 17 is pushed axially into an accommodating pocket 19 on the motor housing 2 and the second fastening part 18 is arranged on the end face of the handle part 4. The sealing element 16 likewise acts as a vibration reduction element and damps vibrations in particular in the axial direction but partly also in the radial direction. The sealing element 16 has an elastically resilient behavior.

The exemplary embodiment according to FIG. 4 shows the sealing of the handle part 4 in the region of its free axial end face relative to the motor housing 2 with the aid of an annular sealing element 16 which acts mainly in the radial direction. Said sealing element 16 is inserted into an annular groove 21 which is made in the lateral surface of the motor housing 2 and is defined axially on one side by the step 13. The sealing element 16 has sealing fingers which project radially outward and bear in a sealing manner against the inner wall of the handle part 4. In addition to the sealing function, a task of the sealing element 16 is also to reduce vibrations. In this case, the reduction of vibrations is effected not only in the radial direction but additionally also in the axial direction.

In the exemplary embodiment according to FIG. 5, in a manner similar to that in FIG. 3, an accommodating pocket 19 which is open axially in the direction of the handle part 4 is made in the motor housing 2, but the annular sealing element 16 is inserted directly into said accommodating pocket 19. The sealing element 16 is acted upon axially by the end face of the cylindrical handle section 5 of the handle part 4, as a result of which, firstly, sealing in the axial and radial directions of the handle part 4 is provided for and, secondly, the vibration-reducing effect of the sealing element 16 can also develop at least in the axial direction.

In the region of the rear axial end face 11 of the motor housing 2, the handle part 4 is connected axially to the motor housing via the connecting element embodied as screw 9, wherein, for isolating vibrations, two damping elements 7 and 8 are arranged on different sides of the base plate or of the connecting element 6 in a manner similar to that in FIG. 1.

In the exemplary embodiment according to FIG. 6, too, an accommodating pocket 19 is located on the motor housing 2 on the side facing the handle part 6, a sealing element 16 being inserted into said accommodating pocket 19. The annular sealing element 16 has an accommodating groove into which the free end face of the handle part 4 is pushed. The sealing element 16 has a U-shaped cross section. As a result, in both the radial direction and the axial direction, there is sufficiently good sealing between handle part 4 and motor housing 2 and a vibration-isolating effect.

In the exemplary embodiments according to FIGS. 7 and 8, the handle part 4 is covered with a vibration-damping coating 22 for additionally reducing the vibration load acting on the operator. As can be seen from FIG. 7, the coating 22 is located both on the outer side of the cylindrical handle section 5 and on the outer side of the base plate 6, it being possible, if need be, to also dispense with the coating of the base plate. The coating 22 consists, for example, of gel-like or elastomeric materials and is provided in the exemplary embodiment according to FIG. 7 with a constant and non-profiled wall thickness. The coating 22 can either be applied subsequently to the handle part 4 or can be sprayed onto the handle part during the process for producing said handle part.

In the exemplary embodiment according to FIG. 8, a coating 22 is likewise provided on the handle part 4. However, the coating 22 is of profiled design and has a multiplicity of handle knobs 23 which extend in the axial direction and in the circumferential direction and are designed to be elastically resilient. The handle knobs 23 increase the surface and thus increase the vibration-reducing effect when the operator takes hold of the handle part.

1. A hand-held power tool, comprising a housing which has at least two separate housing parts to be connected to one another, wherein one housing part forms a handle part configured to hold and guide the hand-held power tool, and a vibration reduction element is arranged between the housing parts, characterized in that wherein at least two vibration reduction elements connected in series are arranged in the force transmission path between the housing parts.

2. The hand-held power tool as claimed in claim 1, wherein a connecting flange is formed on one housing part, and wherein the two vibration reduction elements are held on the connecting flange.

3. The hand-held power tool as claimed in claim 2, wherein the two vibration reduction elements are arranged on different sides of the connecting flange.

4. The hand-held power tool as claimed in claim 1, wherein at least one vibration reduction element has an aperture through which a connecting element is passed.

5. The hand-held power tool as claimed in claim 4, wherein the vibration reduction element is of disk-shaped design.

6. The hand-held power tool as claimed in claim 4, wherein the vibration reduction element is of helical design.

7. The hand-held power tool as claimed in claim 1, wherein the force transmission path runs in the direction of the shaft axis of a drive shaft of a drive motor.

8. The hand-held power tool as claimed in claim 1, wherein the two vibration reduction elements are arranged at the rear end face of the hand-held power tool.

9. The hand-held power tool as claimed in claim 1, wherein at least one further vibration reduction element is arranged at a front axial end face between the handle part and the further housing part.

10. The hand-held power tool as claimed in claim 1, wherein at least one vibration reduction element is embodied configured as a damping element.

11. The hand-held power tool as claimed in claim 1, wherein at least one vibration reduction element is embodied configured as a spring element.

12. The hand-held power tool as claimed in claim 1, wherein at least one vibration reduction element is arranged radially between the housing parts with respect to the shaft axis of a drive shaft.

13. The hand-held power tool as claimed in claim 1, wherein at least one vibration reduction element is arranged axially between the housing parts with respect to the shaft axis of a drive shaft.

14. The hand-held power tool as claimed in claim 1, wherein one housing part forms a motor housing for accommodating a drive motor.

15. The hand-held power tool as claimed in claim 1, wherein the handle part is of pot-shaped design and encloses the further housing part.

16. The hand-held power tool as claimed in claim 1, wherein the outer side of the handle part includes at least partly a friction-increasing material.

17. The hand-held power tool as claimed in claim 16, wherein the handle part has a friction-increasing coating.

18. The hand-held power tool as claimed in claim 16, wherein the outer side of the handle part has a surface-increasing geometry.

19. The hand-held power tool as claimed in claim 18, further comprising handle knobs projecting radially outward, wherein the handle knobs are integrally formed on the outer side of the handle part.

20. (canceled)

21. The hand-held power tool as claimed in claim 17, wherein the friction-increasing coating includes one of a gel-like material and an elastomer.
